(19) United States
(12) Patent Application Publication
(10) Pub. No.: US 2003/0086673 A1
(43) Pub. Date: May 8, 2003

(54) Method and apparatus for managing fiber optic cables

(76) Inventors: Edward Zah, Mamaroneck, NY (US); Hilary L. Farnsworth, New Rochelle, NY (US); Alan J. Wallenberg, Villa Park, IL (US); Carey M. Manson, Mound, MN (US); Michael W. Nagy JR., Naperville, IL (US); Jinloong Yong, Suffern, NY (US); Gregory D. Higgins, Romeoville, IL (US); Alan B. Young, Chappaqua, NY (US)

Correspondence Address: Lawrence M. Cho, Tellabs Operations, Inc., 1415 West Diehl Road, Naperville, IL, 60563, US

(21) Appl. No.: 10/040,261

(22) Filed: Nov. 7, 2001

(51) Int. Cl. G02B 6/00

(52) U.S. Cl. 385/136

(57) ABSTRACT

A cable manager is disclosed according to an embodiment of the present invention. The cable manager includes an eye loop structure that is solderable onto a circuit board.

### FIELD OF THE INVENTION

The present invention relates to cable routing and management devices. More specifically, the present invention relates to a method and apparatus for routing and managing optical fiber cables on an electronic circuit board.

### BACKGROUND

Optical telecommunication devices often include a number optical fiber cables that are routed between components on a printed circuit board. In order to secure the position of the optical fiber cables on the printed circuit board, special handling is required in order to accommodate the optical fiber cables' sensitivity to pinches, sharp turn angles, mechanical and thermal stress.

In the past, various mechanical approaches were used to secure optical fiber cables onto printed circuit boards. One approach involved the use of cable ties to wrap around an optical fiber cable. Cable ties suffered the drawback of requiring an experienced assembler to spend a considerable amount of time to insure that the cable ties did not over stress the optical fiber by over tightening or bending in sharp angles which would result in breakage or micro cracks. A second approach involved the use of tape to tape down optical fibers onto a printed circuit board. Taping down optical fibers typically provided less stress on optical fibers than cable ties. However, taping was found to be less reliable due to the adhesive properties of tape. Fiber cassettes were also used in the past to secure optical fiber cables onto printed circuit boards. Fiber cassettes were typically oval shaped and enclosed the loops of optical fiber cables. Fiber cassettes, however, were expensive to manufacture and required a large amount of space on the printed circuit board which was undesirable.

Thus, what is needed is a reliable, efficient, and cost effective mechanism for securing optical fiber cables onto a printed circuit board.

### SUMMARY OF THE INVENTION

A cable manager is disclosed according to a first embodiment of the present invention. The cable manager includes an eye loop structure that is solderable onto a circuit board.

A cable manager is disclosed according to a second embodiment of the present invention. The cable manager includes an eye loop structure. The eye loop structure includes an eye loop area capable of holding a cable. The eye loop structure also includes a base. The cable manager includes a fastener coupled to the eye loop structure. The fastener is mountable onto a circuit board.

A method for managing a cable is disclosed according to an embodiment of the present invention. A cable manager is soldered onto a circuit board. The cable is routed through a loop area in the cable manager.

### BRIEF DESCRIPTION OF THE DRAWINGS

The features and advantages of the present invention are illustrated by way of example and are by no means intended to limit the scope of the present invention to the particular embodiments shown, and in which:

FIG. 1 illustrates a cable manager according to first embodiment of the present invention;

FIG. 2 illustrates a cable manager according to a second embodiment of the present invention;

FIG. 3 illustrates a cable manager according to a third embodiment of the present invention;

FIG. 4 illustrates a cable manager according to a fourth embodiment of the present invention;

FIG. 5 illustrates an isometric view of a cable manager according to a fifth embodiment of the present invention;

FIG. 6 illustrates a side and front view of the cable manager illustrated in FIG. 5;

FIG. 7 illustrates an isometric view of a cable manager according to a sixth embodiment of the present invention;

FIG. 8 illustrates a side and front view of the cable manager illustrated in FIG. 7;

FIG. 9 illustrates a cable manager according to a seventh embodiment of the present invention;

FIG. 10 illustrates a cable manager according to an eighth embodiment of the present invention;

FIG. 11 illustrates a cable manager mounted on a printed circuit board using a through hole input according to an embodiment of the present invention; and

FIG. 12 illustrates a second cable manager mounted on a printed circuit board using a through hole input according to an embodiment of the present invention.

### DETAILED DESCRIPTION

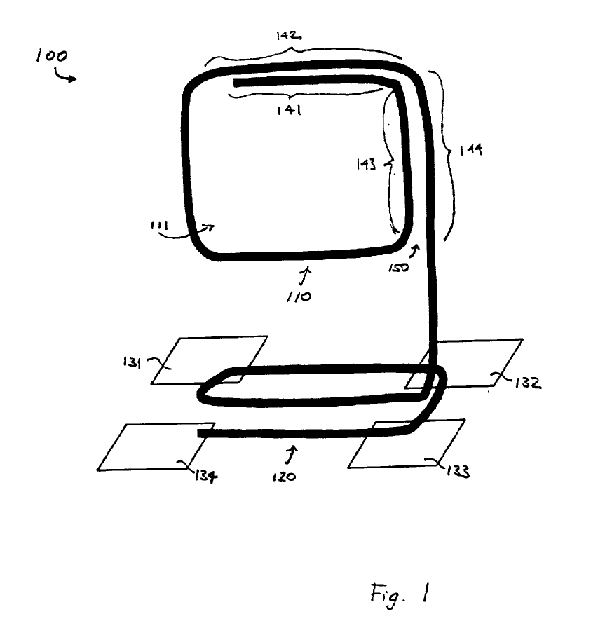

FIG. 1 illustrates a cable manager 100 according to an embodiment of the present invention. The cable manager 100 includes an eye loop structure 110. The eye loop structure 110 defines an eye loop area 111 that is capable of holding a cable (not shown). The eye loop structure 110 includes an opening 150 that allows a cable to be inserted into the eye loop area 111. The eye loop area 111 is an enclosed area that is capable of securing a single cable or a plurality of cables. The eye loop structure 110 allows cables to be added or removed from the eye loop area 111 without requiring the structure of the cable manager 100 to be modified or altered.

According to an embodiment of the cable manager 100, the eye loop structure 110 may be formed using a wire. In this embodiment, the wire shapes the eye loop area 111 and the opening 150. According to an embodiment of the present invention, the wire shaping the eye loop area 111 provides redundant support to a side of the eye loop area 111. As shown in FIG. 1, wire segment 141 and 142 provide redundant support to a top side of eye loop area 111 and wire segment 143 and 144 provide redundant support to a right side of eye loop area 111. Redundant support further secures a cable threaded through the eye loop area 111 and reduces the likelihood of the cable sliding out. It should be appreciated that redundant support may be provided to any number of sides of the eye loop area 111.

The eye loop structure 110 includes a base 120. The base 120 may be coupled to the eye loop structure 110 or be formed from a same structure as the eye loop structure 110. The base 120 forms a plane parallel to a surface that the cable manager 100 may be mounted on to support the eye loop structure 110. According to an embodiment of the cable manager 100, the base 120 may be formed using wire. In this embodiment, the wire forming the base 120 may be shaped in a coil or other geometry that provides the cable manager 100 with a base 120 having sufficient structure to support the eye loop structure 110.

A fastener may be used to couple the eye loop structure 110 to a printed circuit board (not shown). According to an embodiment of the present invention, the fastener may include a plurality of pads 131-134 that are solder pads. According to an alternate embodiment of the present invention, the fastener may include a plurality of pads 131-134 having a first surface and a second surface opposite the first surface. The first surfaces of the pads 131-134 are coupled to the base 120. The second surfaces of the pads 131-134 may be mounted onto a printed circuit board by applying an adhesive material such as a quick curing epoxy or other material. Alternatively, the base 120 of the eye loop structure 110 may be mounted onto a printed circuit board by applying the adhesive material.

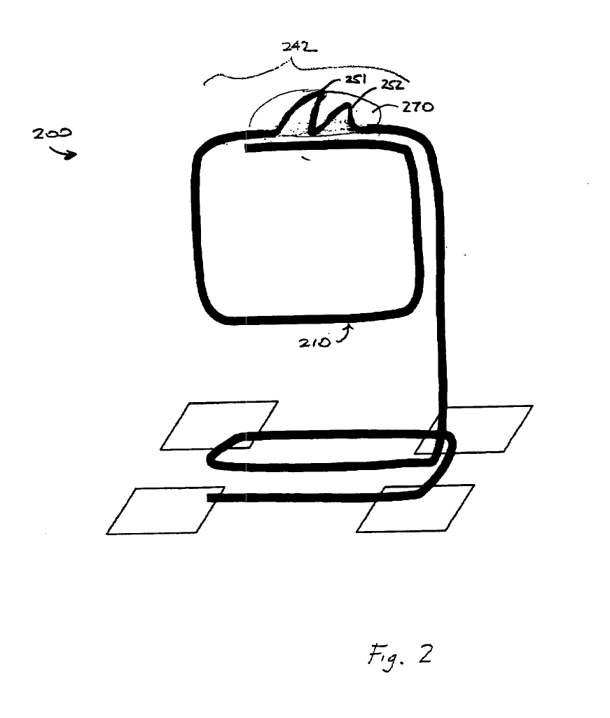

FIG. 2 illustrates a cable manager 200 according to an embodiment of the present invention. The cable manager 200 includes features similar to those shown of the cable manger 100 shown in FIG. 1. The eye loop structure 210 includes a wire segment 242 shaped to allow a pick-up pad 270 to be secured on the eye loop structure 210. The wire segment 242 includes a plurality of ridges 251 and 252 that provides a surface area for the pick-up pad 270 to be secured on the eye loop structure 210. The pick-up pad 270 may be used by an assembler or by an automated assembly machine to handle the cable manager 200. It should be appreciated that the wire segment 242 may be shaped to include any number of ridges or shaped to another geometrical form to allow the pick-up pad 270 to be secured on the eye loop structure 210.

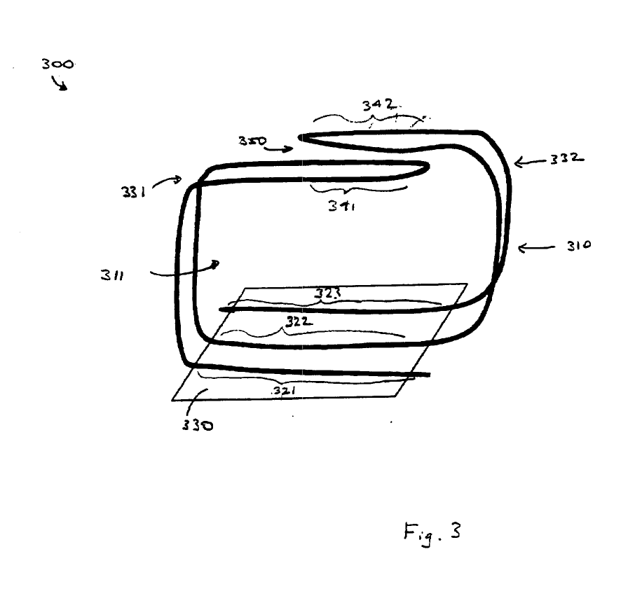

FIG. 3 illustrates a cable manager 300 according to an embodiment of the present invention. The cable manager 300 includes an eye loop structure 310. The eye loop structure 310 defines an eye loop area 311 that is capable of holding a cable (not shown). The eye loop structure 310 includes an opening 350 that allows a cable to be inserted into the eye loop area 311. The eye loop area 311 is an enclosed area that is capable of securing a single cable or a plurality of cables. The eye loop structure 310 allows cables to be added or removed from the eye loop area 311 without requiring the structure of the cable manager 300 to be modified or altered.

According to an embodiment of the cable manager 300, the eye loop structure 310 may be formed using a wire. In this embodiment, the wire shapes two loops that form fingers 331 and 332 that are arranged side by side. A space between the fingers 331 and 332 defines the opening 350 to the eye loop area 311. The fingers 331 and 332 include finger segments 341 and 342, respectively. As shown in FIG. 3, finger segments 341 and finger segments 342 provide redundant support to a top side of eye loop area 311. Redundant support further secures a cable threaded through the eye loop area 311 and reduces the likelihood of the cable sliding out.

The eye loop structure 310 includes a base. According to the embodiment of the present invention shown in FIG. 3, the base is formed by wire segments 321, 322, and 323. Wire segments 321, 322, and 323 define a plane parallel to a surface that the cable manager 300 may be mounted on to support the eye loop structure 310. The wire segments 321, 322, and 323 extend to form the fingers 331 and 332. It should be appreciated that the wire in the cable manager 300 may shape any number of fingers and that redundant support may be provided to any side(s) of the eye loop area 311.

A fastener may be used to couple the eye loop structure 310 to a printed circuit board (not shown). According to an embodiment of the present invention, the fastener may include a pad 330 that is a solder pad. According to an alternate embodiment of the present invention, the fastener may include a pad 330 having a first surface and a second surface opposite the first surface. The first surface of the pad 330 is coupled to the base formed by wire segments 321, 322, and 323. The second surface of the pad 330 may be mounted onto a printed circuit board by applying an adhesive material such as a quick curing epoxv or other material. Alternatively, the base of the eye loop structure 310 may be mounted onto a printed circuit board by applying the adhesive material.

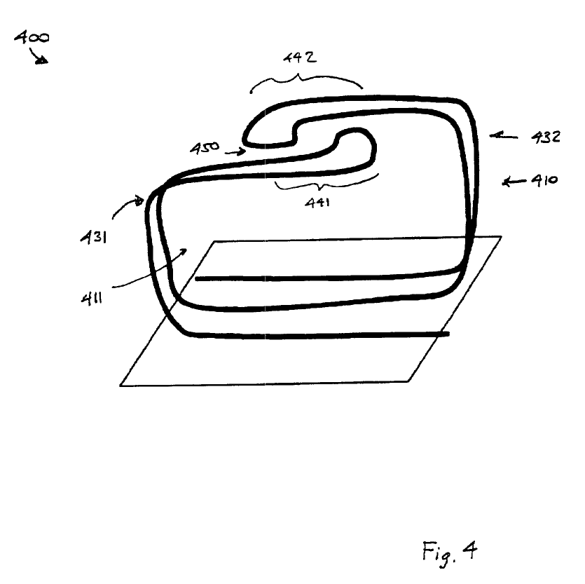

FIG. 4 illustrates a cable manager 400 according to an embodiment of the present invention. The cable manager 400 includes features similar to those shown of the cable manger 300 shown in FIG. 3. The cable manager 400 includes an eye loop structure 410 having fingers 431 and 432 that lay side by side and extend in an interlocking fashion. Finger segment 441 extends towards finger 432 and finger segment 442 extends towards finger 431. According to an embodiment of the present invention, the finger segments 441 and 442 extend approximately ninety degrees towards fingers 432 and 431 respectively. By forming an interlocking structure, the fingers segments 441 and 442 define an opening 450 into the eye loop area 411 that would be more difficult for a cable to slide out once threaded through. It should be appreciated that the finger segments 441 and 442 may extend in other directions in an interlocking fashion.

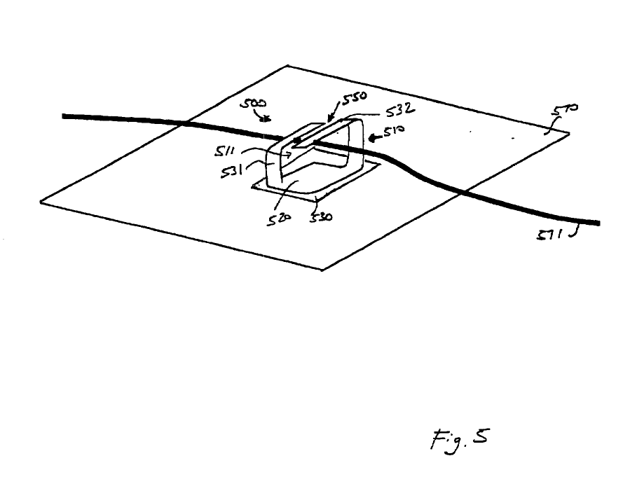

FIG. 5 illustrates a cable manager 500 according to an embodiment of the present invention. The cable manager 500 includes an eye loop structure 510. The eye loop structure 510 defines an eye loop area 511 that is capable of holding a cable 511. The eye loop structure 510 includes an opening 550 that allows a cable to be inserted into the eye loop area 511. The eye loop area 511 is an enclosed area that is capable of securing a single cable or a plurality of cables. The eye loop structure 510 allows cables to be added or removed from the eye loop area 511 without requiring the structure of the cable manager 500 to be modified or altered.

According to an embodiment of the cable manager 500, the eye loop structure 510 may be formed using a sheet of metal. In this embodiment, the sheet of metal two form two fingers 531 and 532 that are arranged side by side. A space between the fingers 531 and 532 defines the opening 550 to the eye loop area 511. The portion of the fingers 531 and 532 that lay side by side provide redundant support to a top side of eye loop area 511. Redundant support further secures the cable 511 threaded through the eye loop area 511 and reduces the likelihood of the cable 511 sliding out.

The eye loop structure 520 includes a base 520. The base 520 may be coupled to the fingers 531 and 532 or formed from the same structure as the fingers 531 and 532. The base 520 forms a plane parallel to a surface that the cable manager 500 may be mounted on to support the eye loop structure 510. It should be appreciated that the cable manager 500 may include any number of fingers and that the fingers may be placed in any position. It should also be appreciated that redundant support may be provided to any side(s) of the eye loop area 511 or to no side at all. For example, the fingers may be positioned such that there is no side by side lying of the fingers and such that there is no redundant support for any of the sides.

A fastener may be used to couple the eye loop structure 510 to a printed circuit board 570. According to an embodiment of the present invention, the fastener may include a pad 530 that is a solder pad. According to an alternate embodiment of the present invention, the fastener may include a pad 530 having a first surface and a second surface opposite the first surface. The first surface of the pad 530 is coupled to the base 520. The second surface of the pad 530 may be mounted onto a printed circuit board by applying an adhesive material such as a quick curing epoxy or other material. Alternatively, the base 520 of the eye loop structure may be mounted onto a printed circuit board by applying the adhesive material.

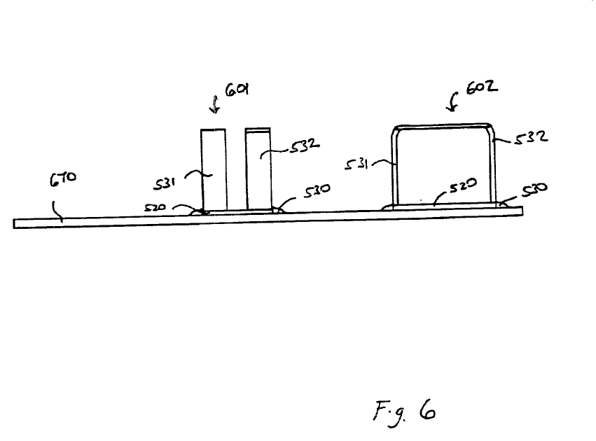

FIG. 6 illustrates a side view perspective of a cable manger 601 and a front view perspective of a cable manager 602 mounted on a printed circuit board 670. The cable managers 601 and 602 may be implemented by the cable manager 500 shown in FIG. 5.

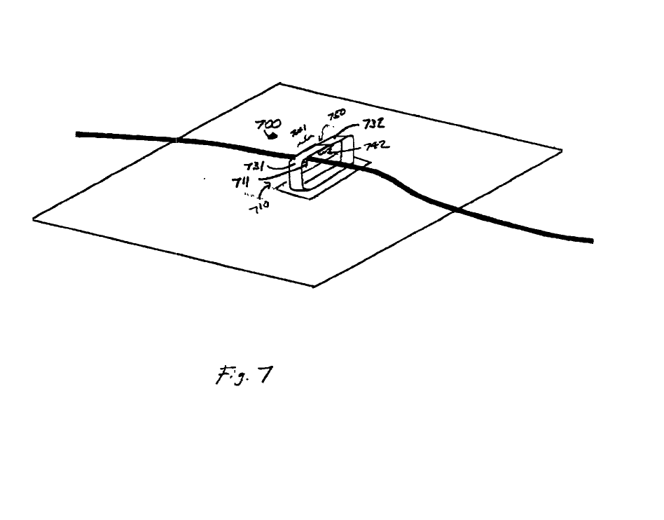

FIG. 7 illustrates a cable manager 700 according to an embodiment of the present invention. The cable manager 700 includes features similar to those shown of the cable manger 500 shown in FIG. 5. The cable manager 700 includes an eye loop structure 710 having fingers 731 and 732 that extend and partially overlap one another. Finger segments 741 and 742 provide redundant support to a top side of the eye loop area 711. By forming an overlapping structure, the fingers segments 741 and 742 define an opening 750 into the eye loop area 711 that would be more difficult for a cable to slide out once threaded through. It should be appreciated that the cable manager 700 may include any number of fingers and that the fingers may be placed in any position. It should also be appreciated that redundant support may be provided to any side(s) of the eye loop area 711 or to no side at all. For example, the fingers may be positioned such that there is no overlap between the fingers and such that there is no redundant support for any of the sides.

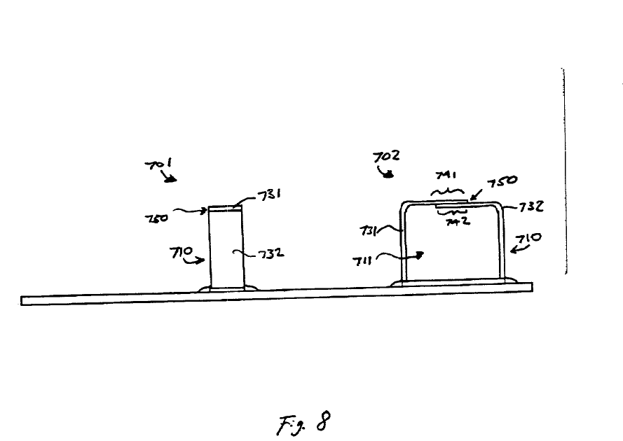

FIG. 8 illustrates a side view perspective of a cable manger 801 and a front view perspective of a cable manager 802 mounted on a printed circuit board 870. The cable managers 801 and 802 may be implemented by the cable manager 700 shown in FIG. 7.

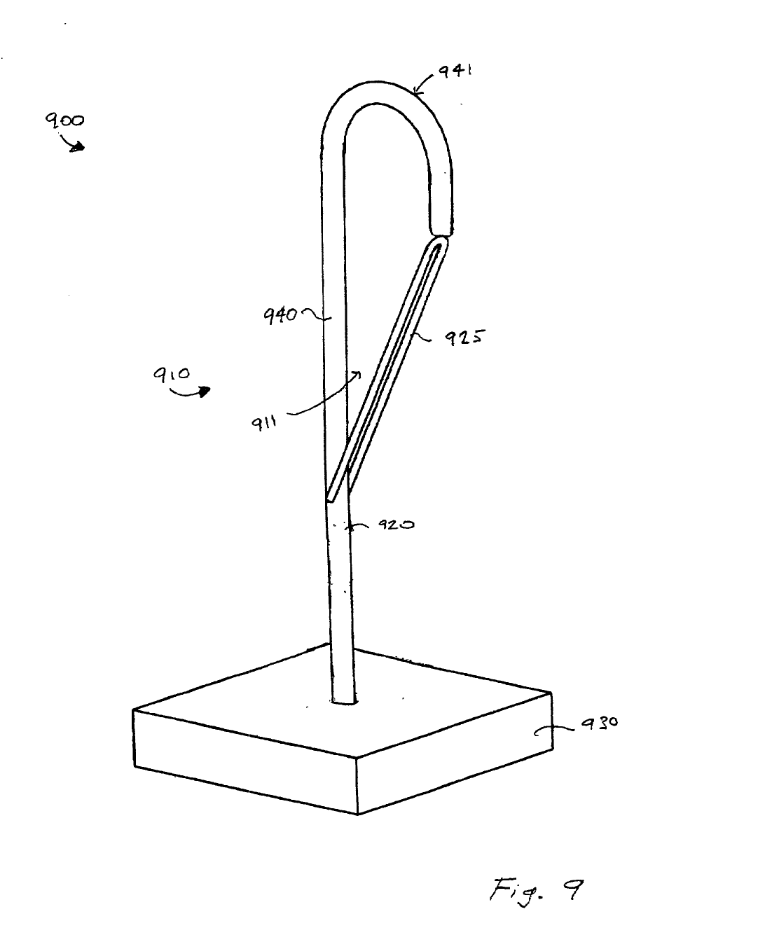

FIG. 9 illustrates a cable manager 900 according to an embodiment of the present invention. The cable manager 900 includes an eye loop structure 910. The eye loop structure 910 includes a hook structure 940 and an arm structure 925. According to an embodiment of the cable manager 900, the hook structure 940 has a rounded edge 941 at its top. Alternatively, the hook structure may have a tapered or coated edge at its top. The arm structure 925 is coupled to the hook structure 940. The arm structure 925 is movable to a plurality of positions. The arm structure 925 may be moved to a first position that together with the hook structure 940 together encloses an eye loop area 911. The enclosed eye loop area 911 is capable of securing a single cable or a plurality of cables. The arm structure 925 may be moved to a second position that opens the eye loop area 911 and allows a cable to be inserted into or removed from the eye loop area 911. The arm structure 925 may be implemented with a spring, an adjustable or flexible lever, a wire strand or other structure. The eye loop structure 910 also includes a base 920. The base 920 may be coupled to the hook structure 940 or formed from a same structure as the hook structure 940.

A fastener may be used to couple the eye loop structure 910 to a printed circuit board (not shown). According to an embodiment of the present invention, the fastener may include a pad 930 that is a solder pad. According to an alternate embodiment of the present invention, the fastener may include a pad 930 having a first surface and a second surface opposite the first surface. The first surface of the pad 930 is coupled to the base 920. The second surface of the pad 930 may be mounted onto a printed circuit board (nct shown) by applying an adhesive material such as a quick curing epoxy or other material. Alternatively, the base 920 of the eye loop structure may be mounted onto a printed circuit board by applying the adhesive material.

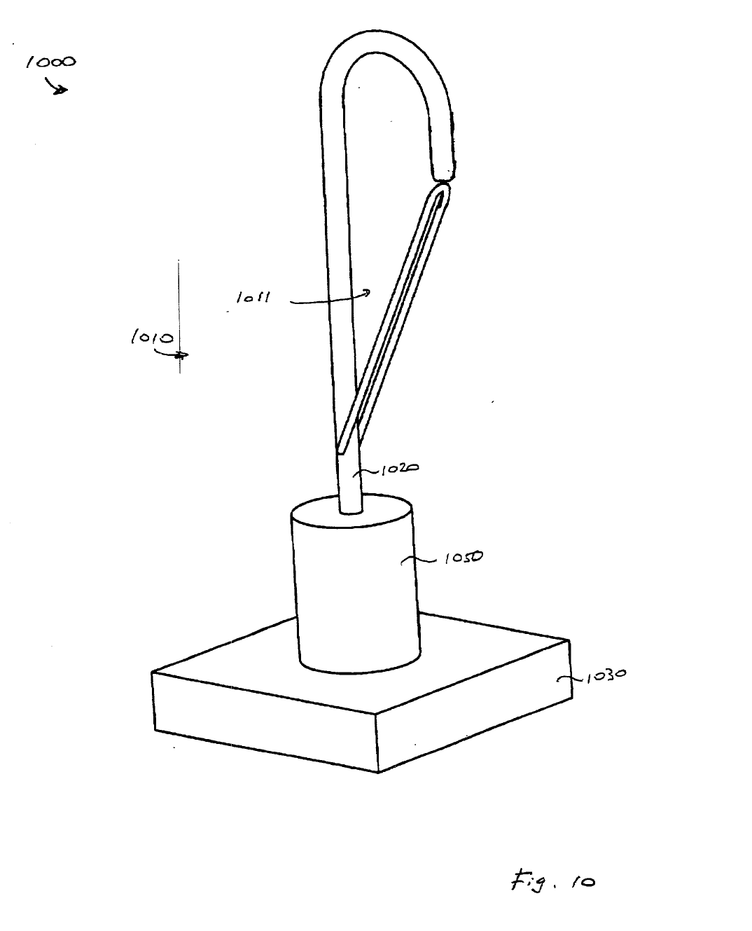

FIG. 10 illustrates a cable manager 1000 according to an embodiment of the present invention. The cable manager 1000 includes features similar to that of the cable manager 900 illustrated in FIG. 9. The cable manager 1000 further includes a base insert 1050. The base insert 1050 may be coupled to the fastener 1030. During assembly, the base 1020 of the eye loop structure 1010 may be coupled to the fastener 1030 by inserting the base 1020 into the base insert 1050. According to an embodiment of the cable manager 1000, the base 1020 and the base insert 1050 are threaded and the base 1020 may be screwed into the base insert 1050. The base insert 1050 allows the eye loop structure 1010 to be rotated 360 degrees such that the eye loop area 1011 may be adjusted to face any direction.

It should be appreciated that the cable managers described and shown in FIGS. 1-10 may implement other components. For example, other fasteners may be used to allow the cable mangers to be mounted on a printed circuit using other techniques. According to an embodiment of the present invention, the cable managers shown in FIGS. 1-10 may implement through hole inserts to mount eye loop structures onto printed circuit boards. A through hole insert may be a wire, pin or other component that allows the cable manager to be mounted on a printed circuit board using through hole assembly techniques.

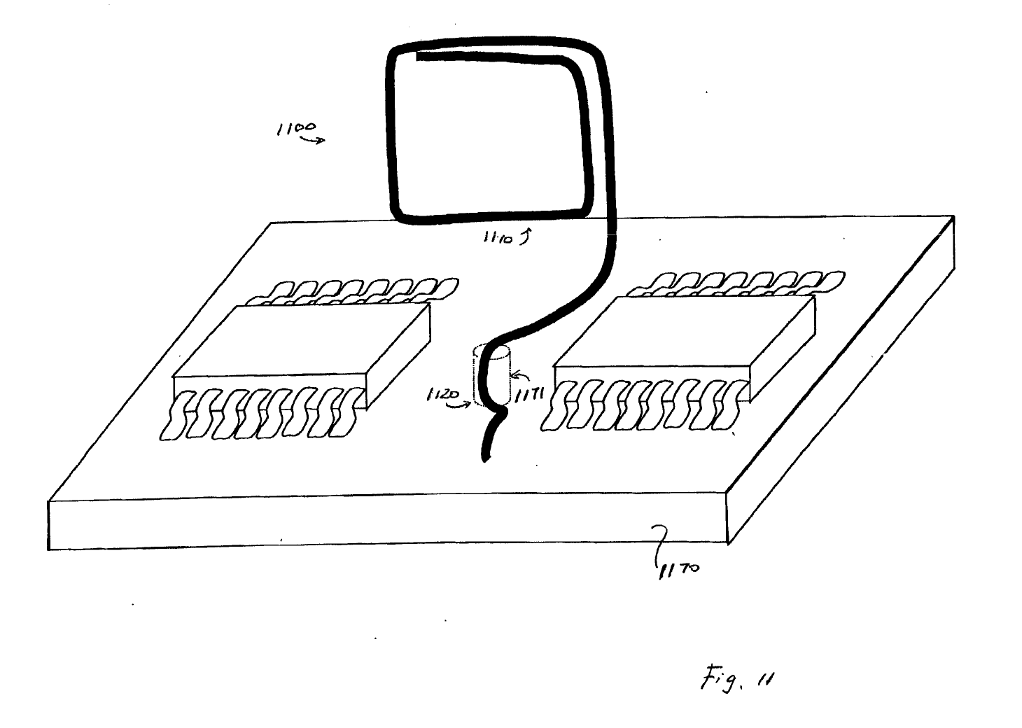

FIG. 11 illustrates an embodiment of a cable manager 1100 with some features similar to the cable manager illustrated in FIG. 1. In this embodiment, the cable manager 1100 may use a base 1120 that is an extension of the wire forming the eye loop structure 1110. The base 1120 is a through hole insert capable of insertion into a hole 1171 on the printed circuit board 1170. The cable manager 1100 may be mounted onto the printed circuit board 1170 by soldering the base 1120.

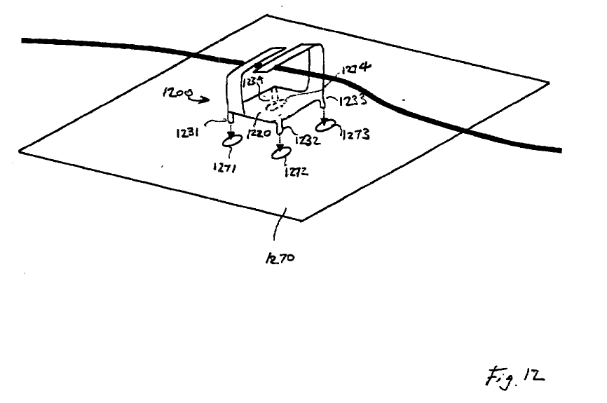

FIG. 12 illustrates an embodiment of a cable manager 1200 with some features similar to the cable manager illustrated in FIG. 5. In this embodiment, the cable manager 1200 may implemented a plurality of pins 1231-1234 coupled to the base 1220 of the cable manager 1200. The pins 1231-1234 are through hole inserts capable of insertion into a plurality of holes 1271-1274 on the printed circuit board 1270. The cable manager 1200 may be mounted onto the printed circuit board 1270 by soldering the pins 1231-1234.

The cable manager described has been shown to be mountable on a printed circuit board. It should be appreciated that the cable manager may be mounted onto any type of semiconductor substrate or surface using the components and techniques described.

According to an embodiment of the present invention, the foot print of the cable managers described may be that of a scale that allows it to be placed around electronic components. This allows the cable managers to be mounted on a printed circuit board using conventional circuit design and manufacturing methods. The cable managers may be constructed using rigid materials that allow the cable managers to be reused and/or re-located. For example, the eye loop structures described may be constructed from components such as tin/lead plated copper, nickel-silver, invar, kovar, berrylium copper, silver, gold, stainless steel, brass or other materials.

In the foregoing specification the invention has been described with reference to specific exemplary embodiments thereof. It will, however, be evident that various modifications and changes may be made thereto without departing from the broader spirit and scope of the invention. The specification and drawings are, accordingly, to be regarded in an illustrative rather than restrictive sense.

What is claimed is:

1. A cable manager, comprising:
an eye loop structure that is solderable onto a circuit board.

2. The cable manager of claim 1, wherein the eye loop structure comprises:
an eye loop area capable of holding a cable; and
a base.

3. The cable manager of claim 1, wherein the base is solderable onto a solder pad.

4. The cable manager of claim 1, wherein the base comprises a through hole insert.

5. The cable manager of claim 2, wherein the eye loop structure comprises a wire.

6. The cable manager of claim 2, wherein the eye loop structure comprises a sheet of metal.

7. The cable manager of claim 2, wherein the eye loop structure further comprises a plurality of fingers that define the eye loop area.

8. The cable manager of claim 7, wherein the plurality of fingers are positioned side by side.

9. The cable manager of claim 7, wherein the plurality of fingers are in an interlocking arrangement.

10. The cable manager of claim 2, wherein the eye loop area is defined by:
a hook structure; and
an arm structure.

11. The cable manager of claim 10, wherein the arm structure comprises a spring.

12. The cable manager of claim 10, wherein the arm structure comprises a movable lever.

13. The cable manager of claim 10, wherein the arm structure comprises a wire strand.

14. The cable manager of claim 1, wherein the eye loop structure comprises copper.

15. The cable manager of claim 1, wherein the eye loop structure comprises tin.

16. The cable manager of claim 1, wherein the eye loop structure comprises lead.

17. A cable manager, comprising:
an eye loop structure having a loop area, capable of holding a cable, and a base; and
a fastener, coupled to the eye loop structure, that is mountable onto a circuit board.

18. The cable manager of claim 17, wherein the fastener comprises a pad that is mountable onto a circuit board with an adhesive.

19. The cable manager of claim 18, wherein the adhesive is a fast cure epoxy.

20. The cable manager of claim 17, wherein the fastener comprises a through hole insert.

21. The cable manager of claim 17, wherein the fastener is coupled to the eye loop structure via a base insert.

22. A method for managing a cable, comprising:
soldering a cable manager onto a circuit board; and
routing the cable through a loop area in the cable manager.

23. The method of claim 22, wherein soldering the cable manager comprises soldering a solder pad on the circuit board.

24. The method of claim 22, wherein soldering the cable manager comprises soldering a through hole insert on the cable manger onto the circuit board.
